(19) United States
(12) Patent Application Publication
(10) Pub. No.: US 2008/0135645 A1
(43) Pub. Date: Jun. 12, 2008

(54) System and Method for a Vacuum Inducing Nozzle

(75) Inventor: Ernest H. Wilkinson, Houston, TX (US)

Correspondence Address: JESSICA W. SMITH, 1529 PARKVIEW DRIVE, GARLAND, TX, 75043, US

(73) Assignee: VACUUM INDUCING NOZZLE, LLC., Houston, TX (US)

(21) Appl. No.: 11/608,824

(22) Filed: Dec. 9, 2006

(51) Int. Cl. B05B 1/00; B05B 7/06

(52) U.S. Cl. 239/432

(57) ABSTRACT

A nozzle has a cylindrical conduit section with a power fluid inlet, an outlet and a pumped fluid inlet at a location between the power fluid inlet and the outlet; a straightening vane plate sealed across the power fluid inlet including a plurality of straightening vanes situated around a pass thru conduit; a wing support and tube attached to the straightening vane plate that provides a passageway for the power fluid pass thru conduit and extends across the pumped fluid inlet; and a circular wing structure attached to an end of the wing support and tube, wherein the circular wing structure has a nosed shaped profile. The nosed shaped profile has a first face having an outer diameter larger than the wing support and tube and a rounded portion with a slope that decreases to almost parallel to the walls of the cylindrical section. The circular wing structure then has a tapering portion that tapers down again to a diameter similar to the wing support and tube. The tip of the circular wing structure forms an opening or power fluid outlet for the power fluid pass thru conduit. In an alternate embodiment, rather than a straightening vane plate, the cylindrical conduit includes a tapered section that forms a narrow opening in the cylindrical conduit upstream from the pumped fluid inlet. A power fluid conduit extends through the narrow opening in the tapered section and across the pumped fluid inlet.

### BACKGROUND OF THE INVENTION

1. Field of the Invention

This invention relates to nozzles, and more particularly nozzles that include a pumped fluid inlet.

2. Description of the Related Art

A typical nozzle for a fluid flow includes a housing with a high pressure power inlet to a generally cylindrical conduit, wherein fluid, either a liquid or a gas or a mixture thereof, at a high pressure passes into the power fluid inlet and flows through the cylindrical conduit along an axis in parallel to the walls of the cylindrical conduit. The cylindrical conduit has an outlet downstream from the power inlet for flow of the fluid into another line or container or the air.

A modified jet pump was described in prior U.S. Pat. No. 5,454,696, entitled, “Vacuum Inducing Pump.” As shown in FIG. 1, the description of this jet pump 10 includes a power fluid inlet 12, a generally cylindrical conduit section 14 and an outlet 16 spaced downstream from the power inlet. In addition, the jet pump includes a pumped fluid inlet 18 including a conduit 20 opening into the cylindrical conduit section 14 at a location between the power fluid inlet 12 and the outlet 16. Extending across the pumped fluid inlet 18 is a power fluid inlet structure 22 that has a first plate 24 sealed relative to the power fluid inlet. A small power fluid inlet conduit 26 having a passage begins at the first plate 24 and goes through a second plate 26. The second plate 26 is likewise sealed against the conduit section 14 downstream from the pumped fluid inlet 18. The second plate 28 provides a plurality of passages 30 for providing communication between the pumped fluid inlet 18 and downstream of the power fluid inlet structure 22.

In use, a relatively high pressure fluid, either gas, liquid or a mixture thereof, passes through the power fluid inlet 12 into the power fluid inlet conduit 26. As the volume decreases, the velocity of the fluid increases substantially and the pressure in the housing adjacent the downstream end of the second plate 28 is thereby lowered substantially. This creates a low pressure area open to the pumped fluid inlet 18 inducing flow of a pumped fluid into the housing. Downstream of the second plate, the power fluid and pumped fluid commingle and then pass through the outlet 16. One or more diffusers 32 may also be used to slow down the fluid flow and raise the pressure of the commingled stream.

This known jet pump directs all flow of the power fluid through the small power fluid conduit 26. The power fluid and pumped fluid do not mix until after the second plate 28. This known jet pump has disadvantages in efficiency for certain applications.

Thus, an improved method for creating a low pressure area around the pumped fluid inlet and for mixing the power fluid and pumped fluid is needed.

### BRIEF SUMMARY OF THE INVENTION

The nozzle in this embodiment of the invention includes a cylindrical conduit section with a power fluid inlet, an outlet and a pumped fluid inlet at a location between the power fluid inlet and the outlet; a straightening vane plate sealed across the power fluid inlet including a plurality of straightening vanes situated in a circular fashion about a small pass thru conduit; a wing support and tube attached to the straightening vane plate that provides a passageway for the pass thru conduit and extends across the pumped fluid inlet; and a circular wing structure attached to an end of the wing support and tube, wherein the circular wing structure has a nosed shaped profile.

The nosed shaped profile has a first face having an outer diameter larger than the wing support and tube and a rounded portion with a slope that decreases to almost parallel to the walls of the cylindrical section. Then the nosed shaped profile has an expanding portion that sharply slopes up again before leveling to a parallel with the cylindrical conduit section. The circular wing structure then has a tapering portion that tapers down again to a diameter similar to the wing support and tube. The tip of the circular wing structure forms an opening or power fluid outlet for the pass thru conduit.

In use, a high pressure power fluid is pumped into the power fluid inlet and forced into the straightening vanes and the pass thru conduit. As the fluid exits the straightening vanes at a high velocity along the outside of the wing support and tube. This high velocity fluid creates a low pressure area around the pumped fluid inlet inducing flow of a fluid, either gas, liquid or mixture thereof, into the pumped fluid inlet. Then, when the fluid flow reaches the circular wing, it impinges on the nosed shaped profile and quickly decreases in velocity as it spreads across the entire volume of the cylindrical conduit section. As the fluid hits the sides of the cylindrical conduit section, it circulates back around creating a circular flow around the mid section of the circular wing. This circular flow creates a high pressure area ideal for mixing the fluids. The mixture of the fluids is further facilitated by the high velocity stream of a portion of the high pressure fluid exiting at the power fluid outlet of the circular wing tip.

In an alternate embodiment, the nozzle includes a cylindrical conduit with a power fluid inlet, an outlet and a pumped fluid inlet at a location between the power fluid inlet and the outlet. A tapered section forms a narrow opening in the cylindrical conduit upstream from the pumped fluid inlet, and a power fluid conduit extends through the narrow opening in the tapered section and across the pumped fluid inlet. A circular wing structure is attached to the power fluid conduit, wherein the circular wing structure has a nosed shaped profile and includes a continuation of the conduit for the power fluid.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates an existing jet pump system.

FIGS. 2a, 2b and 2c illustrate one embodiment of the nozzle of the present invention.

FIGS. 3a, 3b and 3c illustrate another embodiment of the nozzle of the present invention.

FIG. 4 illustrates use of one embodiment of the nozzle in a well system.

FIG. 5 illustrates use of one embodiment of the nozzle in a system for cleaning oil spills.

FIG. 6 illustrates use of one embodiment of the nozzle in an air conditioning system.

FIG. 7 illustrates another embodiment of the nozzle of the present invention.

### DETAILED DESCRIPTION OF THE INVENTION

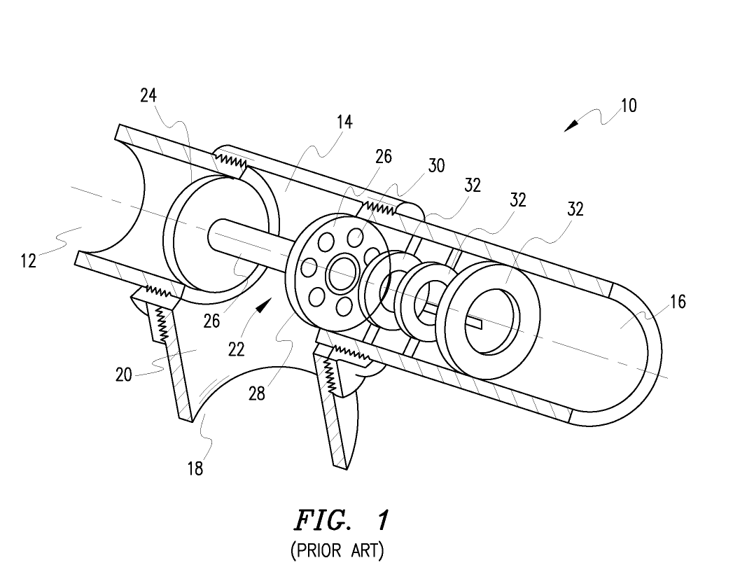

The present invention is best understood in relation to FIGS. 1 through 7 of the drawings, like numerals being used for similar elements of the various drawings. The following description includes various specific embodiments of the invention but a person of skill in the art will appreciate that the present invention may be practiced without limitation to specific details described herein.

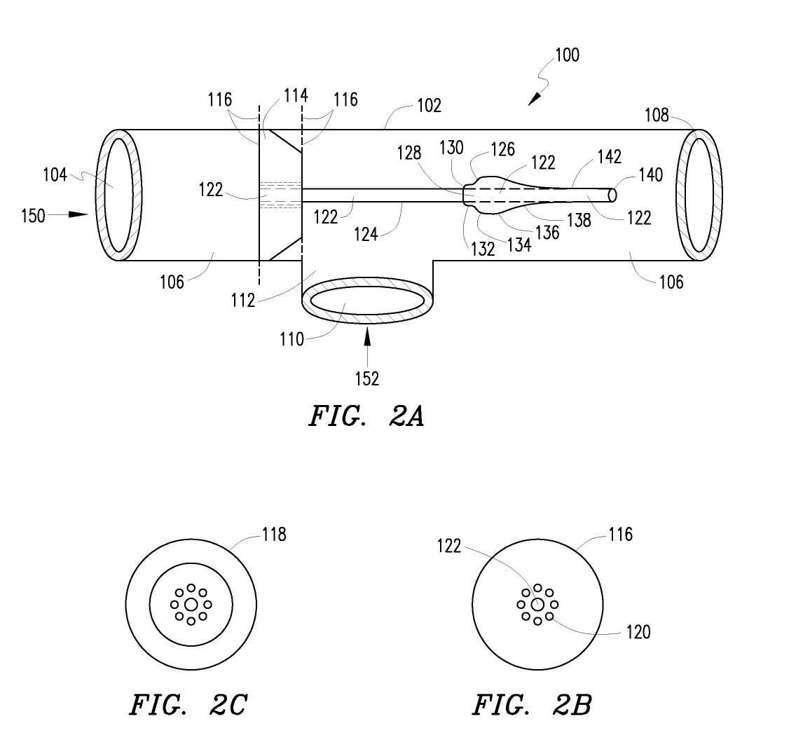

FIG. 2 illustrates one embodiment of the nozzle 100 of the present invention. As shown in FIG. 2, the nozzle 100 in this embodiment of the invention includes a housing 102 having a power fluid inlet 104, a generally cylindrical conduit 106 and an outlet 108 spaced downstream from the power fluid inlet 104. In addition, the nozzle 100 includes a pumped fluid inlet 110 including a conduit 112 opening into the cylindrical conduit 106 at a location between the power fluid inlet 104 and the outlet 108. Extending across an opening provided by the power fluid inlet 104 is a straightening vane plate 114 structure that is sealed relative to the power fluid inlet 104. To illustrate the structure of the straightening vane plate 114, a first face 116 of the plate 114 is shown in FIG. 2b and a second face 118 of the plate 114 is shown in FIG. 2c.

As shown in FIG. 2b, the first face 116 of the straightening vane plate 114 is preferably circular to provide a seal along the walls of the cylindrical conduit 106. The straightening vane plate 114 includes a plurality of small conduits or straightening vanes 120 that run through the straightening vane plate 114. These straightening vanes 120 are situated about a pass thru conduit 122. In a preferred embodiment, the pass thru conduit 122 runs from the center of the first face 116 to the center of the second face 118. The straightening vanes 120 are positioned around the pass thru conduit 122 and closer to the pass thru conduit 122 than the circumference of the faces 116 or 118. The pass thru conduit 122 has a slightly larger diameter than the straightening vanes 120.

The straightening vane plate 114 tapers to a smaller diameter second face 118. FIG. 2c illustrates the second face 118 of the straightening vane plate 114. At the second face 118, the straightening vanes 120 open into the cylindrical conduit 106. However, the pass thru conduit 122 continues through a wing support and tube 124. The wing support and tube 124 is welded into or screwed into the straightening vane plate 114. The wing support and tube 124 provides a tube or passageway or conduit for the pass thru conduit 122. The wing support and tube 124 preferably extends across the pumped fluid inlet 110 and is roughly in the center of the cylindrical conduit 106.

Downstream from the pumped fluid inlet 110, the wing support and tube 124 is connected to a circular wing structure 126. The circular wing structure 126 preferably has a nosed shaped profile 128 with a first face 130 having an outer diameter larger than the wing support and tube 124. The nosed shaped profile 128 then has a rounded portion 132 with a slope that decreases to almost parallel to the conduit walls. Then the nosed shaped profile 128 has an expanding portion 134 that sharply slopes up again before leveling to a parallel 136 with the conduit section 106. After the nosed shaped profile 128, the circular wing structure 126 then has a tapering portion 138 that tapers down again to a diameter similar to the wing support and tube 124.

The wing structure 126 forms an inner tube or passageway for the pass thru conduit 122. The tip 142 of the circular wing structure 126 forms an opening or power fluid outlet 140 for the pass thru conduit 122. Thus, in the embodiment of FIG. 2, the pass thru conduit 122 extends through the straightening vane plate 114, through the wing support and tube 124 and the circular wing structure 126. It preferably has a roughly constant diameter throughout each structure.

FIG. 2 shows example dimensions that are for illustrative purposes of one embodiment of the nozzle. These example dimensions are not limiting to other embodiments of the nozzle and may be varied depending on application of the nozzle within the ability of a person of average skill in the art.

In operation, a high pressure power fluid, either a liquid, gas or combination thereof, flows into the power fluid inlet 104 from a pump, high pressure well or other source. At the straightening vane plate 114, since it is sealed against the walls of the conduit section 106, the power fluid 150 is forced into the straightening vanes 120 and the pass thru conduit 124. Since the power fluid 150 passes through a decreasing area, the velocity of the power fluid 150 increases. With increasing flow velocity of the power fluid 150, the pressure decreases. A portion of the volume of the power fluid 150 flows through the pass thru conduit at a high velocity and exits at the power fluid outlet 140. The remaining volume of the power fluid 150 flows through the straightening vanes 120. As this volume of power fluid 150 exits the straightening vanes at a high velocity, due to viscous friction, a boundary layer of the power fluid 150 keeps the flow along the outside of the wing support and tube 124. This high velocity fluid creates a low pressure area around the pumped fluid inlet 110 drawing a pumped fluid 152, either liquid or gas or mixture thereof, into the conduit 112 and cylindrical conduit 106.

Then, when the power fluid 150 flow reaches the circular wing 126 at a high velocity, it impinges on the nosed shaped profile 128 and quickly decreases in velocity as it spreads across the entire volume of the conduit section 106. As the fluid hits the sides of the conduit section 106, it circulates back around creating a circular flow around the mid section of the circular wing 126. This circular flow creates an area ideal for mixing the power fluid 150 and pumped fluid 152. The mixture of the power fluid 150 and pumped fluid 152 is further facilitated by the high velocity stream of a portion of the power fluid 150 exiting at the power fluid outlet 140.

The embodiment of the nozzle 100 has advantages over the known jet pump shown in FIG. 1. In the known jet pump of FIG. 1, all the power fluid was passed through a conduit to the downstream side of the pumped fluid inlet 110. In this embodiment of the nozzle 100, some volume of the power fluid 150 flows through straightening vanes 120 into the cylindrical conduit 106 and over the pumped fluid inlet. In addition, the nosed shaped profile of the circular wings improves the quick expansion of the power fluid 150 and mixture of the power fluid 150 and pumped fluid 152.

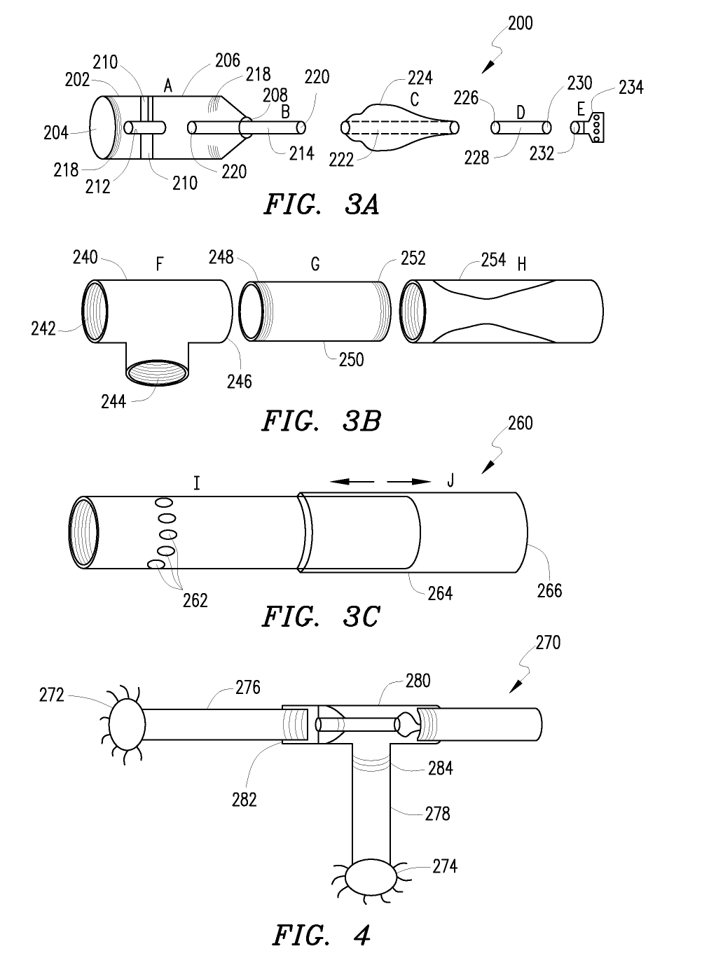

FIGS. 3a, 3b and 3c illustrate another embodiment of a nozzle 200 of the present invention. FIG. 3a illustrates a first portion of the nozzle 200 in this embodiment of the invention. As seen in FIG. 3a, a power fluid inlet housing 202 having a power fluid inlet 204 includes a generally cylindrical portion 206 that tapers to a narrow power fluid outlet 208 spaced downstream from the power fluid inlet 204. Thus, the power fluid inlet housing 202 includes a tapered section that forms the narrow power fluid outlet 208. In addition, power fluid inlet housing 202 includes one or more supports 210 that support a first power fluid conduit 212. The supports 210 and power fluid conduit 212 are welded to or molded as part of the power fluid inlet housing 202.

The first power fluid conduit 212 is roughly in the center of the housing 202. The first power fluid conduit 212 attaches to a second power fluid conduit 214 by threads 220 that screw into the end of the first power fluid conduit 212. The second power fluid conduit 214 extends through the power fluid outlet 208. A small ring shaped opening is formed between the tapered section of the power fluid outlet 208 and the power fluid conduit. The second power fluid conduit 214 attaches to a circular wing structure 224 by threads 220. The circular wing structure 224 is similar in design to the circular wing structure 126 of FIG. 2a. The circular wing structure 224 also includes a conduit that forms an extension to the power fluid conduits 212 and 214. In FIG. 3a, this extension is labeled as third power fluid conduit 222. Thus, the power fluid may flow through the first power fluid conduit 212 to the second power fluid conduit 214 and through to the third power fluid conduit 222 formed by the circular wing structure 126.

An optional fourth power fluid conduit extension 228 can be attached to the circular wing structure 224 as needed for certain applications. The extension 228 allows for the power fluid to flow from the third power fluid conduit 222 formed by the circular wing structure 126 to the power fluid outlet 230. In some embodiments as explained below, a sprayer head 234 may be attached to the fourth power fluid conduit extension 228 by threads 232.

FIG. 3b illustrates another portion of the nozzle 200 in this embodiment of the invention. A T-shaped conduit 240 includes a power fluid inlet 242, a pumped fluid inlet 244 and fluid outlet 246. The T-shaped conduit 240 attaches to the power fluid housing 202 by threads 218. When attached in the preferred embodiment of the present invention, the second power fluid conduit 214 extends over the pumped fluid inlet 244 such that the power fluid outlet 208 of the power fluid housing 202 is upstream of the pumped fluid inlet 244 and the circular wing structure 224 is downstream of the pumped fluid inlet 244. A housing extension 250 is attached by threads 248 to the fluid outlet 246 of the T-shaped conduit 240. The housing extension 250 is of sufficient length to enclose the circular wing structure 224 and power fluid conduit extension 228. In addition, an optional nozzle piece 254 may be attached to the housing extension 250 by threads 252.

In operation of an embodiment of the invention, the first T-shaped conduit 240 is attached to the power fluid housing 202 and the housing extension 250. Within the enclosure formed by the power fluid housing 202, T-shaped conduit 240 and the housing extension 250, the second power fluid conduit 214 is attached to the first power fluid conduit 212 and the circular wing structure 224. The second power fluid conduit 214 extends over the pumped fluid inlet 244 such that the power fluid outlet 208 of the power fluid housing 202 is upstream of the pumped fluid inlet 244 and the circular wing structure 224 is downstream of the pumped fluid inlet 244. A fourth power fluid conduit extension 228 is attached to the circular wing structure 224 within the housing extension 250 as well.

A high pressure power fluid 150, either a liquid, gas or combination thereof, flows into the power fluid inlet 204 from a pump, high pressure well or other source. A small portion of the power fluid 150 is forced into the first power fluid conduit 212. The remaining portion of the power fluid 150 is forced through the ring shaped opening between the tapered section at the power fluid outlet 208 of the power fluid housing 202 and the second power fluid conduit 214. Since the power fluid 150 passes through a decreasing area in the tapered section, the velocity of the power fluid 150 increases. As this volume of power fluid 150 exits the ring shaped opening at the power fluid outlet 208, due to viscous friction, a boundary layer of the power fluid 150 keeps the flow along the outside of the second power fluid conduit 214. This high velocity power fluid creates a low pressure area around the pumped fluid inlet 244 drawing a pumped fluid 152, either liquid or gas or mixture thereof, into the T-shaped conduit 240.

Then, when the power fluid 150 flow reaches the circular wing 224 at a high velocity, it impinges on the nosed shaped profile and quickly decreases in velocity as it spreads across the entire volume of the conduit. As the fluid hits the sides of the conduit, it circulates back around creating a circular flow around the mid section of the circular wing 224. This circular flow creates an area ideal for mixing the power fluid 150 and pumped fluid 152. To increase the velocity of the mixture, the optional nozzle piece 254 may be attached to the housing extension 250. The nozzle piece 254 reduces the area and increases the velocity of the mixture of the power fluid 150 and pumped fluid 152. This increase in velocity is further facilitated by the high velocity stream of a portion of the power fluid 150 exiting the fourth power fluid conduit extension 228.

FIG. 3c illustrates another embodiment of the nozzle. In this embodiment, a nozzle housing 260 is attached to the power fluid housing 202 by threads 218. The nozzle housing 260 includes a ring of openings 262. The ring of openings 262 are formed in a ring around a circumference of the nozzle housing 260. The nozzle housing 260 also includes an adjustable extension 264. The adjustable extension is attached so that it may slide back or retract to shorten the nozzle housing 260 or to slide forward or extend to lengthen the nozzle housing 260. The adjustable extension 264 includes one or more latches or other mechanisms to secure the extension into place in either the extended or retracted position.

In operation of this embodiment of the nozzle, the second power fluid conduit 214 preferably extends across the ring of openings 262 when it is attached to the first power fluid conduit 212. The circular wing structure 224 is preferably downstream from the ring of openings 262 when attached to the second power fluid conduit 214. In addition for certain applications, the sprayer head 234 is preferably attached to the fourth power fluid conduit extension 228 which is attached to the circular wing structure 224. The sprayer head 234 preferably extends outside of the nozzle housing outlet 266 when the adjustable extension 264 is retracted. When extended, the adjustable extension preferably encloses the sprayer head 234.

This embodiment of the nozzle in FIG. 3c is ideal for a fire hose. For example, in use, high pressure water or other fluid is pumped into the power fluid inlet 204. A small portion of the water is forced into the first power fluid conduit 212. The remaining portion of the water is forced through the ring shaped opening between the tapered section at the power fluid outlet 208 of the power fluid housing 202 and the second power fluid conduit 214. Since the water passes through a decreasing area, the velocity of the water increases. As this volume of power fluid 150 exits the narrow power fluid outlet 208, due to viscous friction, a boundary layer of the water keeps the flow along the outside of the second power fluid conduit 214. This high velocity water creates a low pressure area around the ring of openings 262 drawing air into the nozzle housing 262.

Then, when the power fluid 150 flow reaches the circular wing 224 at a high velocity, it impinges on the nosed shaped profile and quickly decreases in velocity as it spreads across the entire volume of the conduit. As the fluid hits the sides of the conduit, it circulates back around creating a circular flow around the mid section of the circular wing 224. This circular flow creates a high pressure area ideal for mixing the water and air. To increase the velocity of the mixture, the sprayer head 234 is attached to the fourth power fluid conduit 228. The high velocity stream of a portion of the power fluid 150 exiting the fourth power fluid conduit extension 228 enters the sprayer head 234. The centrifugal force of the water because of the angle and position of the exit holes in the sprayer head 234 makes the sprayer head 234 rotate. For a broad spray of water, the adjustable extension 264 is retracted such that the sprayer head is positioned outside of the outlet 266. This broad spray is more ideal for a heat screen for entry to a burning area. For a more concentrated spray to an isolated area, the adjustable extension 264 is extended over the sprayer head 234 and locked into place. The adjustable extension 264 directs the water flow to a more concentrated area. The higher velocity water from the sprayer head 234 also helps to extend the reach of the water. This ability to quickly adjust the area of coverage of the water is ideal for fighting large fires where different capabilities may be quickly needed depending on the situation faced by a firefighter.

The above described embodiments of the nozzle have many other applications in different fields of endeavor. A few such applications are described with respect to FIGS. 4 through 6 below, though such applications are not exhaustive.

FIG. 4 illustrates use of the nozzle 280 in a well system 270, for example a gas or oil well system. The embodiment of the nozzle 280 in FIG. 4 may be similar to the embodiment of the nozzle 100 in FIG. 2 or the embodiment of the nozzle 200 in FIGS. 3a and 3b though other embodiments and variations within the scope of the claims may also be used. The power fluid inlet 282 of the nozzle 280 is connected to a well 272 through a flow line 276. The pumped fluid inlet 284 is connected to well 274 through a flow line 278. The fluid, gas or liquid or mixture thereof, in well 272 is at higher pressure and/or produces a larger quantity of fluid than the well 274. As explained above, the nozzle 280 creates a low pressure region over the pumped fluid inlet 284 and thus increases the flow of the fluid from well 274.

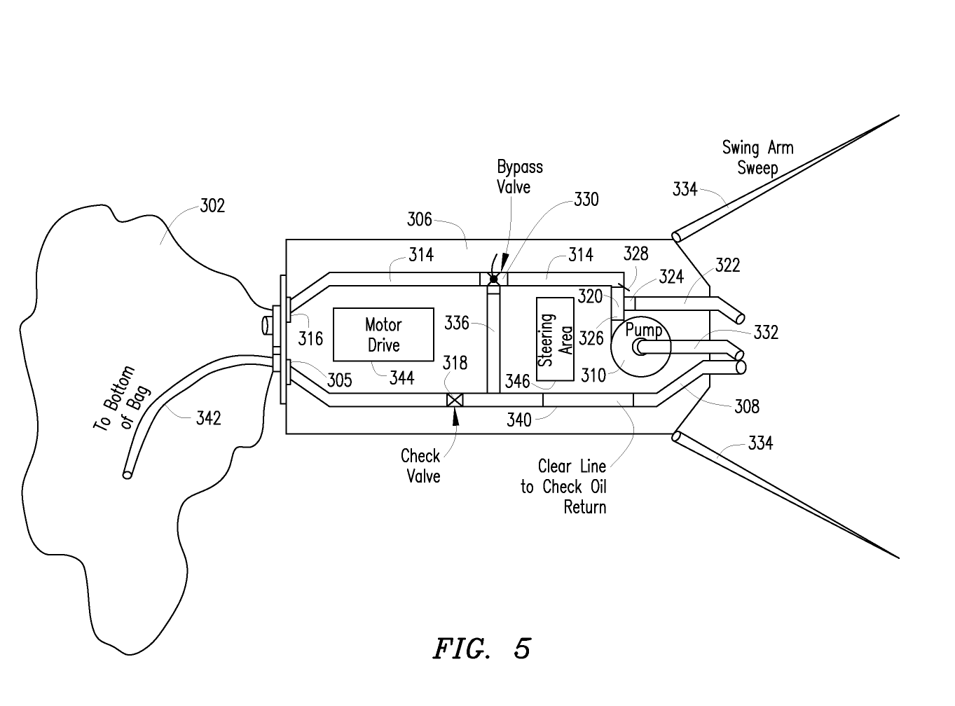

FIG. 5 illustrate use of the nozzle in a system 300 for cleaning oil spills in a body of water, such as a bay, gulf, sea, etc. . . . The FIG. 5a illustrates a top view of a boat 306 with a steering area 346 and motor drive 344. A large collection bag 302 is connected to the back of the boat 306. The bag 302 includes a discharge outlet 305 and bag inlet 316. Preferably the discharge outlet 305 and bag inlet 316 are shaped differently to correspond to the correct hoses to avoid incorrect installation. The discharge outlet 305 is located at the bottom of the bag 302 and is connected by water discharge line 308 outside of the boat. The pump 310 is connected to water inlet house 332 and to the power fluid inlet 326 of nozzle 320. The embodiment of the nozzle 320 may be similar to the embodiment of the nozzle 100 in FIG. 2 or the embodiment of the nozzle 200 in FIGS. 3a and 3b though other embodiments and variations thereof may also be used.

A collection hose 322 is connected to the pumped fluid inlet 324 of the nozzle 320. A delivery hose 314 is connected to the outlet 328 of the nozzle 320 and to an upper bag inlet 316. A bypass valve 330 is connected to a bypass hose 336 between the delivery hose 314 and the water discharge line 308. A check valve 318 is located in the water discharge hose 308 upstream of the connection to the bypass hose 336. Two swing arm sweeps 334 are connected to the front of the boat to aid in collection of the oil/water mixture. The swing arm sweeps 334 may be stationary or may be able to rotate to help consolidate the oil at the front of the boat 306.

In operation, water and oil is pumped from the body of water through a floating inlet hose 332 by pump 310. The pumped, high pressure water flows through power fluid inlet 326 of nozzle 320 creating a low pressure area over the pumped fluid inlet 324. The oil to be removed is drawn through the floating inlet hose 322 into the pumped fluid inlet 324 by this low pressure. The circular wing structure in the nozzle 320 slows down the water from the pump 310 and helps to draw the oil/water being collected. This oil/water mixture flows through delivery hose 314 to upper bag inlet 316. The oil in the oil/water mixture floats to the top of the bag 302 while the water falls to the bottom to be discharged through a water discharge line extension 342 through discharge outlet 305 to water discharge line 308. When enough oil is collected to fill a bag, then oil will be discharged from discharge outlet 305 to water discharge line 308. The discharge line 308 includes a clear sight tube 340 near the operator's position so he can observe the oil in the water discharge line 308. Other mechanisms may also be used to detect oil in the water discharge line 308. This presence of oil in the discharge line 308 indicates that the bag 302 is full of oil and needs to be changed. The operator manually or other mechanism may automatically activate the bypass valve 330. The bypass valve 330 switches the flow of the oil/water mixture from the delivery hose 314 through the bypass hose 336 to the discharge hose 308. The check valve 318 prevents the flow of oil/water mixture from the bypass hose 336 to the discharge outlet 305. The bag 302 that is now filled with oil can then be sealed and another bag installed to collect more oil.

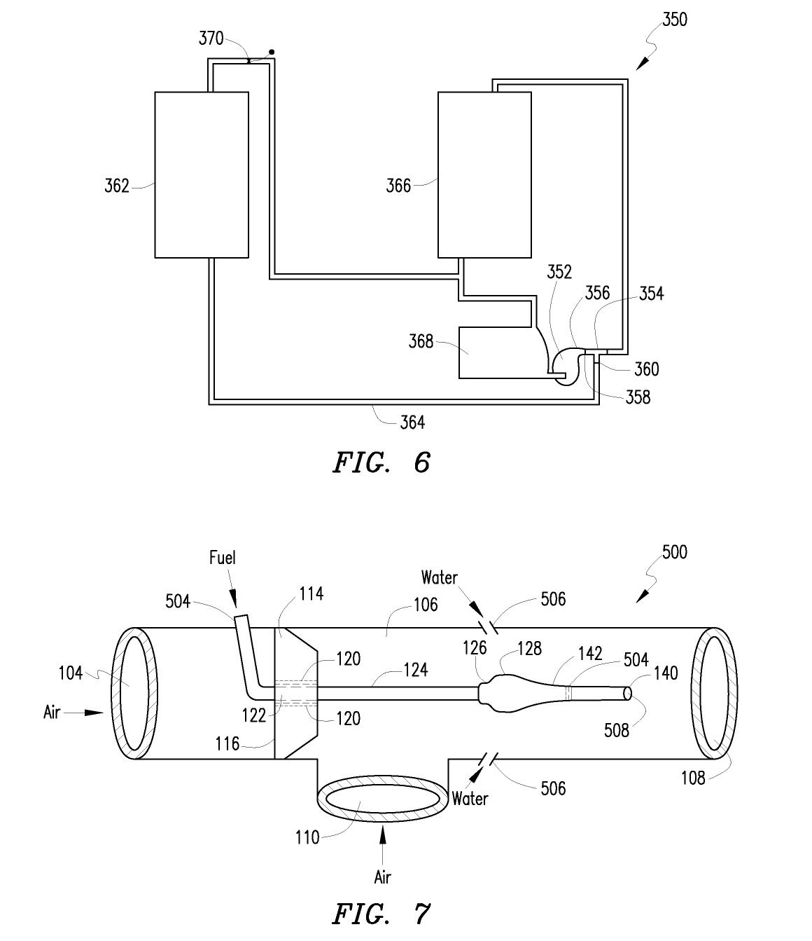

FIG. 6 illustrates an application of the nozzle in an air conditioning system 350. The most expensive part of most air conditioners is the compressor. In this embodiment of the invention, the compressor is replaced by a pump 352 and the nozzle 354. The embodiment of the nozzle 354 in FIG. 6 may be similar to the embodiment of the nozzle 100 in FIG. 2 or the embodiment of the nozzle 200 in FIGS. 3a and 3b though other embodiments and variations thereof may also be used. The pump 352 is connected by a pump line 356 to the power fluid inlet 358 of the nozzle 354. The pumped fluid inlet 360 of the nozzle 354 is connected to an outlet of an inside exchanger or cooling coils 362 by hose 364. The inside exchanger 362 are filled with a refrigerant, such as water, ammonia, Freon or any other expandable fluid. In the inside exchanger 362, the Freon gas is cool and at a low pressure and absorbing the heat from the air inside. The pump 352 and nozzle 354 create a low pressure area around the pumped fluid inlet 360 drawing in the Freon gas from inside exchanger 362. The gas is then compressed by the nozzle 354. The gas becomes hotter with increased pressure. The hot gas flows through the outside exchanger 366 which includes heat dissipating coils so it can dissipate its heat, and condenses into a liquid. This cool liquid flows to reservoir 368 back through pump 352 to the nozzle 354. Another part of the Freon liquid runs through an expansion or needle valve 370, and in the process it expands and evaporates to become cold, low-pressure Freon gas that flows through the inside exchange 362. Thus, this cold Freon gas absorbs heat and cools down the air around the cooling coils in the inside exchange 362 before being drawn back into the pumped fluid inlet 360 of nozzle 354.

FIG. 7 illustrates another embodiment of the nozzle. The nozzle 500 shown in FIG. 7 is similar to the nozzle 100 in FIG. 2, but a person of skill in the art would understand that the nozzle 200 in FIGS. 3a and 3b may also be used as well. In this embodiment, a fuel injector hose 504 is connected to the pass thru conduit 122 at the first face 116 of the straightening vane plate 114. In the circular wing structure 126, the outlet 104 is shut by a cap 508 or welded shut. The circular wing tip 142 includes a plurality of fuel openings 504. The nozzle 500 also includes one or more water intake valves 506 in the conduit section 106 around the circular wing 126.

The nozzle 500 may be used for various applications such as a steam generator. For the steam generator, high pressure air is forced into the power fluid inlet 104. Since the opening to the pass thru conduit 122 is closed by the fuel injector tube 504, all the pressurized air flows through the straightening vanes 120. As this compressed air exits the straightening vanes at a higher velocity, a low pressure area is created around the pumped fluid inlet 110. This low pressure area induces flow of a fluid through the pumped fluid inlet 110. The fluid may be additional air or a catalyst depending on the desired application. Then, when the air flow reaches the circular wing 126 at a high velocity, it impinges on the nosed shaped profile 128 and decreases in velocity as it spreads across the entire volume of the conduit section 106. As the air hits the sides of the conduit section 106, it circulates back around creating a circular flow around the mid section of the circular wing 126. In addition, water is introduced into the cylindrical conduit 106 from one or more of the water intake valves 506 at the mid section of the circular wing 126. This circular flow of air creates a high pressure area ideal for mixing the air and water. At the same time, fuel is injected in the fuel injector 504. The fuel may be a gas or liquid or mixture thereof. For example, the fuel may be ethanol or hydrogen gas. The fuel is forced through the fuel openings 504 and quickly expands releasing heat into the air and water mixture. This air and water mixture is thus quickly heated into steam. The steam flows out the outlet 108.

Though only a few applications have been described, various embodiments of the nozzle may be used in many different fields for different purposes. Although the Detailed Description of the invention has been directed to certain exemplary embodiments, various modifications of these embodiments, as well as alternative embodiments, will be suggested to those skilled in the art. The invention encompasses any such modifications or alternative embodiments that fall within the scope of the Claims.

1. A nozzle, comprising:
a cylindrical conduit with a power fluid inlet, an outlet and a pumped fluid inlet at a location between the power fluid inlet and the outlet;
a straightening vane plate sealed across the power fluid inlet including a plurality of straightening vanes situated around a pass thru conduit;
a wing support and tube attached to the straightening vane plate that provides a passageway for the pass thru conduit, wherein the wing support and tube extends across the pumped fluid inlet; and
a circular wing structure attached to the wing support and tube, wherein the circular wing structure has a nosed shaped profile and passageway for the pass thru conduit.

2. The nozzle of claim 1, wherein the nosed shaped profile of the circular wing structure includes:
a first face having an outer diameter larger than the wing support and tube;
a rounded portion with a slope that decreases to almost parallel to walls of the cylindrical conduit; and
an expanding portion that sharply slopes up again before leveling to generally parallel with the cylindrical conduit section.

3. The nozzle of claim 2, wherein the nosed shaped profile further includes a tapering portion that tapers down to a tip, wherein the tip forms an outlet for the pass thru conduit.

4. The nozzle of claim 3, wherein the straightening vane plate includes a first face sealed across the power fluid inlet and a second face tapered to a smaller circumference.

5. The nozzle of claim 4, wherein the plurality of straightening vanes situated around a pass thru conduit have a smaller diameter than the pass through conduit and are located adjacent to the pass thru conduit.

6. A nozzle, comprising:
a cylindrical conduit with a power fluid inlet, an outlet and a pumped fluid inlet at a location between the power fluid inlet and the outlet;
a tapered section that forms a narrow opening in the cylindrical conduit upstream from the pumped fluid inlet;
a power fluid conduit that extends through the narrow opening in the tapered section and across the pumped fluid inlet; and
a circular wing structure attached to the power fluid conduit, wherein the circular wing structure has a nosed shaped profile and includes a continuation of the conduit for the power fluid.

7. The nozzle of claim 6, further comprising:
a power fluid conduit extension attached to the circular wing structure.

8. The nozzle of claim 7, wherein the nosed shaped profile of the circular wing structure includes:
a first face having an outer diameter larger than the wing support and tube;
a rounded portion with a slope that decreases to almost parallel to walls of the cylindrical conduit; and
an expanding portion that sharply slopes up again before leveling to generally parallel with the cylindrical conduit section.

9. The nozzle of claim 8, wherein the nosed shaped profile further includes a tapering portion that tapers down to a tip, wherein the tip forms an outlet for the pass thru conduit.

10. The nozzle of claim 9, wherein a small ring shaped opening is formed between the tapered section and the power fluid conduit.

11. A nozzle, comprising:
a cylindrical housing with a power fluid inlet and an outlet and a plurality of openings formed in the cylindrical housing between the power fluid inlet and outlet;
a tapered section that creates a narrowing inside the cylindrical housing upstream from the plurality of openings;
a power fluid conduit that extends through the tapered section and through the cylindrical housing with the plurality of openings; and
a circular wing structure attached to the power fluid conduit, wherein the circular wing structure has a nosed shaped profile and includes a continuation of the power fluid conduit.

12. The nozzle of claim 11, wherein the plurality of openings are formed in a ring around a circumference of the cylindrical housing.

13. The nozzle of claim 12, further comprising an adjustable extension that retracts to shorten the cylindrical housing or extends forward to lengthen the cylindrical housing.

14. The nozzle of claim 13, further comprising a sprayer head attached to the circular wing structure to receive fluid through the continuation of the power fluid conduit.

15. The nozzle of claim 14, wherein the sprayer head is positioned within the adjustable extension when the adjustable extension is extended.

16. The nozzle of claim 15, wherein the sprayer head is positioned outside the adjustable extension when the adjustable extension is retracted.

17. The nozzle of claim 16, wherein the one or more latches or other mechanisms to secure the adjustable extension in either its extended or retracted position.
